(19) United States
(12) Patent Application Publication
(10) Pub. No.: US 2010/0172021 A1
(43) Pub. Date: Jul. 8, 2010

(54) LASER MICROSCOPE

(75) Inventor: Motohiko SUZUKI, Kawasaki-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/727,694

(22) Filed: Mar. 19, 2010

Related U.S. Application Data
(63) Continuation of application No. 10/856,890, filed on May 27, 2004, now abandoned.

(30) Foreign Application Priority Data
May 30, 2003 (JP) 2003-155634

(51) Int. Cl. G02B 21/06

(52) U.S. Cl. 359/389

(57) ABSTRACT

A laser microscope comprises a laser light source which emits a laser light, an objective lens which condenses the laser light from the laser light source onto a specimen, an optical scanning unit which two-dimensionally scans the laser light on the specimen, a beamsplitter which separates light emitted from a condensed position on the specimen of the laser light from the laser light source, the beamsplitter being disposed between the objective lens and the optical scanning unit, an optical fiber in which an incident end is disposed at an optical path separated by the beamsplitter, and to which the light from the specimen is made to be incident, and a spectroscope which is disposed at an exit end of the optical fiber, and to which light from the specimen which is emitted from the exit end is made to be incident.

### CROSS-REFERENCE TO RELATED APPLICATIONS

The present application is a Continuation application of U.S. application Ser. No. 10/856,890 filed May 27, 2004, which is based upon and claims the benefit of priority from prior Japanese Patent Application No. 2003-155634, filed May 30, 2003, the entire contents of both of which are incorporated herein by reference.

### BACKGROUND OF THE INVENTION

1. Field of the Invention

The present invention relates to a laser microscope which radiates a laser light onto a specimen by scanning, and which detects the light from the specimen.

2. Description of the Related Art

The laser microscope is configured as follows. A laser light from a laser light source is condensed on a specimen by an objective lens. The condensed point of the laser light is two-dimensionally scanned optically by using a scanner. Then, a light (in particular, fluorescence) from the specimen is detected by a photo detector via an objective lens. As a result, two-dimensional information of the specimen is obtained. In the laser microscope having such a configuration, a light from positions other than a focal point position can be cut out by using a confocal pinhole. Therefore, it is known that a resolution of the laser microscope is improved in an optical axis direction. By using this characteristic, a plurality of two-dimensional slice images are acquired while varying the relative positional relationship between the objective lens and the specimen. Further, a three-dimensional image of the specimen can be acquired due to the two-dimensional images being three-dimensionally structured.

On the other hand, a laser microscope is known in which spectroscopic detection of a light emitted by the specimen is possible by disposing a spectroscope at a photo detecting optical path.

For example, in Jpn. Par. Appln. KOKAI Publication No. 2000-56244 or No. 2002-14043, there is disclosed a confocal laser microscope as the following. A spectroscope is disposed at a photo detecting optical path of a confocal laser microscope, and a light (fluorescence, Raman scattering) emitted by a specimen is wavelength-separated. Then, due to the light which has been wavelength-separated being detected by a photo detector, the light emitted from the specimen is spectrally detected.

Further, in the same Jpn. Pat. Appln. KOKAI Publication No. 2000-56244 or No. 2002-267933, there is disclosed a confocal laser microscope in which a light from a specimen is transmitted to a spectroscope via an optical fiber, and the light is wavelength-separated.

Both of these techniques relate to a confocal laser microscope. In the former, after the light emitted from the specimen is returned to a scanner and is descanned thereby, the light is made to be incident onto a spectroscope via a confocal pinhole disposed at the conjugate position with an observation plane. With respect to the latter as well, after the light from the specimen is descanned, the light is made to be incident onto an incident end plane of the optical fiber disposed at the conjugate position with the observation plane, and the light is led to the spectroscope. In this case, a diameter of the incident end plane of the optical fiber must be the same as a diffraction limited spot diameter of the light to be incident thereon, and because it must be a sufficiently small diameter, a single mode fiber is used.

By the way, recently, there has been put to practical use a multiple-photon laser microscope using an IR ultrashort pulsed laser. The multiple-photon laser microscope is configured so as to generate a multiple-photon phenomenon only on the focal point position of the specimen on which the IR ultrashort pulsed laser is irradiated, by using the IR ultrashort pulsed laser. In the multiple-photon laser microscope, due to fluorescence being emitted by exciting a fluorescence indicator by a multiple-photon phenomenon, a specimen image only on the focal plane can be acquired. Accordingly, a confocal pinhole needed for obtaining a high resolution in a direction along the optical axis before now can be fallen into disuse.

Further, with respect to the multiple-photon laser microscopes, focusing on the point that the confocal pinhole can be fallen into disuse, a multiple-photon laser microscope configured such that fluorescence from a specimen is led to a fluorescent detector side on the middle of an optical path before descanning the fluorescence by a scanner is considered (refer to Japanese Patent No. 3283499).

### BRIEF SUMMARY OF THE INVENTION

A laser microscope according to an aspect of the present invention is characterized by comprising: a laser light source which emits a laser light; an objective lens which condenses the laser light from the laser light source onto a specimen; an optical scanning unit which two-dimensionally scans the laser light on the specimen; a beamsplitter which separates light emitted from a condensed position on the specimen of the laser light from the laser light source, the beamsplitter being disposed between the objective lens and the optical scanning unit; an optical fiber in which an incident end is disposed at an optical path separated by the beamsplitter, and to which the light from the specimen is made to be incident; and a spectroscope which is disposed at an exit end of the optical fiber, and to which light from the specimen which is emitted from the exit end is made to be incident.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram illustrating a schematic configuration of a first embodiment of the present invention;

FIG. 2 is a diagram for explanation of a relationship between a projection lens and an incident end plane of a bundle fiber for use in the first embodiment;

FIG. 3 is a diagram for explanation of a relationship between an exit end of the bundle fiber and a slit of a spectroscope for use in the first embodiment;

FIG. 4 is a diagram illustrating a schematic configuration of the spectroscope for use in the first embodiment;

FIG. 5 is a diagram Illustrating a schematic configuration of a second embodiment of the present invention;

FIG. 6 is a diagram for explanation of a relationship between an exit end of a multi-mode fiber and a slit of a spectroscope for use in the second embodiment; and

FIG. 7 is a diagram illustrating a schematic configuration of a main portion of a third embodiment of the present invention.

### DETAILED DESCRIPTION OF THE INVENTION

Hereinafter, embodiments of the present invention will be described with reference to the drawings.

### First Embodiment

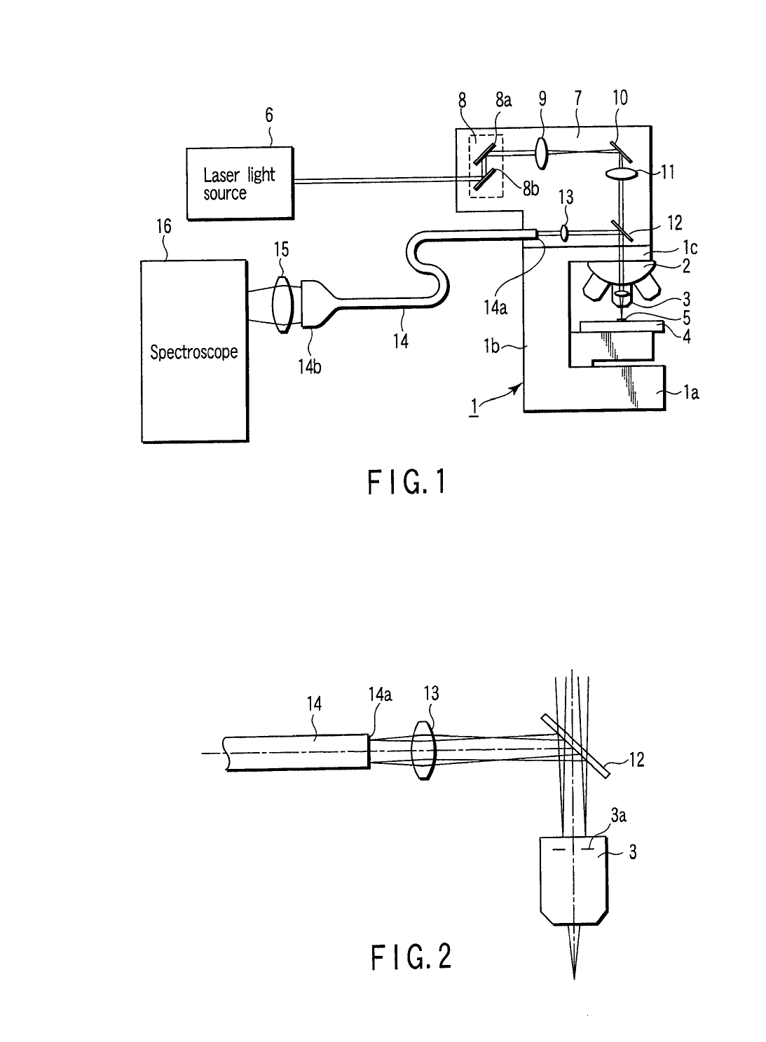

FIG. 1 illustrates a schematic configuration of a laser microscope to which the present invention is applied.

In FIG. 1, a microscope main body 1 has a body portion 1b provided so as to be upright at a base portion 1a in the horizontal direction. Further, an arm portion 1c is provided at a front end of the body portion 1b so as to be parallel with the base portion 1a.

A revolver 2 is provided at the arm portion 1c of the microscope main body 1. The revolver 2 holds a plurality of objective lenses 3, and the objective lens 3 can be selectively positioned on the optical axis of a observation optical path by rotating the revolver 2.

A stage 4 is disposed at the body portion 1b of the microscope main body 1. A specimen 5 is placed on the stage 4. The stage 4 vertically moves along the optical axis direction of the objective lens 3 positioned on the observation optical path, by a focusing mechanism (not shown).

A laser light source 6 radiates an IR ultrashort pulsed laser light (IR ultrashort pulsed coherent light) onto an observation plane of the specimen 5. In accordance therewith, a nonlinear phenomenon due to multiple-photon absorption arises on the observation plane of the specimen 5.

An optical unit 7 is disposed at the optical path of the IR ultrashort pulsed laser light emitted from the laser light source 6. The optical unit 7 is disposed above the arm portion 1c of the microscope main body 1. The optical unit 7 has a scanner 8 serving as light scanning means, a relay lens 9, a reflection mirror 10, an image formation lens 11, a dichroic mirror 12 serving as wavelength separating means, and a projection lens 13.

The IR ultrashort pulsed laser light emitted from the laser light source 6 is incident to the scanner 8. The scanner 8 has scanning mirrors 6a, 8b by which the IR ultrashort pulsed laser light is scanned in directions perpendicular to each other, thereby the IR ultrashort pulsed laser light is deflected in two-dimensional directions by the scanning mirrors 8a, 8b. The light two-dimensionally deflected at the scanner 8 transmits through the relay lens 9, and thereafter, it's optical path is reflected by the reflection mirror 10. Then, the reflected light transmits through the dichroic mirror 12 from the image formation lens 11, and is incident into the objective lens 3 so as to fill the diameter of a pupil of the objective lens 3. The dichroic mirror 12 has the characteristic such that the IR ultrashort pulsed laser light emitted from the laser light source 6 is made to transmit through, and the light from the specimen 5 which will be described later is reflected and deflected (separated).

The light which has transmitted through the objective lens 3 is condensed onto the specimen 5 on the stage 4. In this case, the condensed point on the specimen 5 is two-dimensionally scanned optically. Further, on the specimen 5, a nonlinear phenomenon due to multiple-photon absorption arises on the focal plane of the objective lens 3 by the IR ultrashort pulsed laser light, and light such as fluorescence, Raman scattering, or the like is emitted.

The light emitted from the specimen 5 is taken into the objective lens 3, and is transmitted from the objective lens 3, and thereafter, the light is reflected and deflected (separated) by the dichroic mirror 12.

The projection lens 13 and an incident end plane 14a of an optical fiber, here, the bundle fiber 14 are disposed at the separated optical path by the dichroic mirror 12. The projection lens 13 is used for projecting the pupils 3a of the objective lens 3 onto the incident end plane 14a of the bundle fiber 14 as shown in FIG. 2. The incident end plane 14a of the bundle fiber 14 is positioned at the conjugate position with the pupils of the objective lens 3.

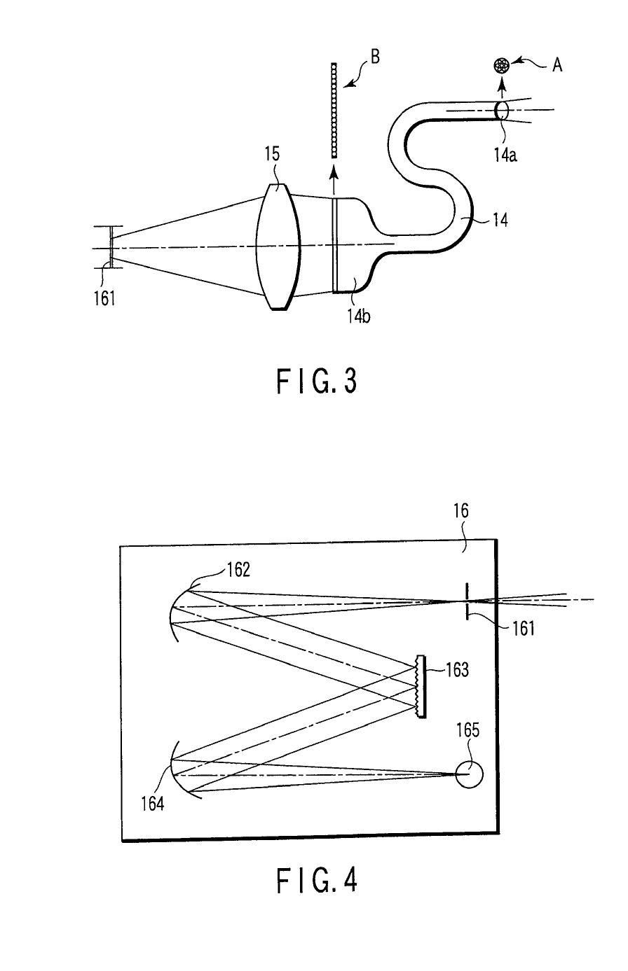

A condensing lens 15 and a spectroscope 16 are disposed at the exit end 14b side of the bundle fiber 14. In this case, the incident end plane 14a of the bundle fiber 14 is formed to be a circular shape as shown by A in FIG. 3. An exit end 14b of the bundle fiber 14 is formed to be a shape in which fiber bundles are rectilinearly arranged as shown by B of FIG. 3. Further, a light emitted from the exit end 14b is condensed on a rectilinear slit 161 at an incident opening of the spectroscope 16 by the condensing lens 15. Namely, the rectilinear exit end 14b of the bundle fiber 14 is disposed so as to be parallel to the slit 161 of the spectroscope 16, whereby the light, from the exit end 14b is efficiently transmitted to the slit 161 of the spectroscope 16.

FIG. 4 is a diagram illustrating a schematic configuration of the spectroscope 16. In the spectroscope 16, the slit 161 is disposed at the condensed position of the condensing lens 15 described above. The light which has passed through the slit 161 is made to be a parallel beam by being reflected on a concave mirror 162, and the parallel beam is incident onto a reflection type diffraction grating 163. Then, the light spectrally diffracted at the diffraction grating 163 is further reflected at a concave mirror 164, and is detected at a photo detector 165. Further, the detected light is converted into an electric signal, transmitted to a computer (not shown), and then data-processed. In this case, the slit 161 of the spectroscope 16 is disposed in a direction perpendicular to the direction of dispersing of the light at the diffraction grating 163. In accordance therewith, the direction of arrangement of the fiber bundles of the exit end 14b of the bundle fiber 14 is a direction perpendicular to the direction of dispersing of the light at the spectroscope 16.

Note that the configuration of the spectroscope 16 is merely one example, and another configuration may be used.

Next, the operation of the multiple-photon laser microscope configured as described above will be described.

When an IR ultrashort pulsed laser light (IR ultrashort pulsed coherent light) is emitted from the laser light source 6, the laser light is incident to the scanner 8 of the optical unit 7. The laser light is then deflected by the scanning mirrors 8a, 8b which respectively scan the laser light in perpendicular directions, and transmits through the relay lens 9. The optical path of the laser light which has transmitted through the relay lens 9 reflects by the mirror 10, and the laser light is incident to the objective lens 3 so as to fill the diameter of the pupil of the objective lens 3.

The light which has transmitted through the objective lens 3 is condensed onto the specimen 5 on the stage 4. In this case, the condensed point on the specimen 5 is two-dimensionally scanned optically.

On the specimen 5, a nonlinear phenomenon due to multiple-photon absorption arises at the focal point position of the objective lens 3 by the IR ultrashort pulsed laser light, and light such as fluorescence, Raman scattering, or the like is emitted.

The light emitted from the specimen 5 is taken into the objective lens 3, from the objective lens 3, and then reflected and deflected (separated) at the dichroic mirror 12. Namely, the light emitted from the specimen 5 does not return to the scanner 8, but is separated at the dichroic mirror 12 in front of the scanner 8. The light separated by the dichroic mirror 12 is incident to the incident end plane 14a of the bundle fiber 14 via the projection lens 13. In this case, the pupil of the objective lens 3 is being projected onto the incident end plane 14a of the bundle fiber 14 by the projection lens 13, and the light from the specimen 5 is made to be incident thereto in a state of being two-dimensionally deflected.

In this case, the incident end plane 14a of the bundle fiber 14 is formed to be a circular shape as shown by A in FIG. 3. Accordingly, the circular-shaped light beam, from the specimen 5, whose angle varies in accordance with two-dimensional deflection can be thoroughly taken. Further, the exit end 14b of the bundle fiber 14 is formed to be a shape in which fiber bundles are rectilinearly arranged in accordance with the shape of the slit 161 of the spectroscope 16 as shown by B of FIG. 3, and the emitted light from the exit end 14b is changed into a light beam rectilinearly arranged. Accordingly, even when the angles of the light emitted from the respective fiber bundles are varied in accordance with two-dimensional deflections, the emitted lights can be thoroughly led to the narrow slit 161 by being condensed by the condensing lens 15. As a result, because the emitted light from the specimen 5 can be led to the inside of the spectroscope 16 efficiently, a high signal-to-noise ratio spectroscopic detection can be realized.

Thereafter, the light condensed on the slit 161 of the spectroscope 16 is converted into a parallel beam by the concave mirror 162, and the parallel beam is led to the diffraction grating 163. Then, the light from the diffraction grating 163 is reflected at the concave mirror 164, and is detected at the photo detector 165. The detected light is converted into an electric signal and is data-processed by a computer (not shown), so that a spectroscopic detection is carried out.

As described above, in the present embodiment, the laser microscope is configured such that the light emitted from the specimen 5 by the laser light two-dimensionally deflected on the specimen 5 is separated to the spectroscope 16 side by the dichroic mirror 12 without being returned to the scanner 8. In accordance therewith, as compared with a conventional case in which the light is made to be incident to a spectroscope by being descanned by a scanner, in the present embodiment, a loss of light on half the optical path up to the spectroscope 16 can be made to be a minimum. Therefore, even a extremely feeble light such as fluorescence, Raman scattering, or the like, of a nonlinear phenomenon, which is emitted from the specimen 5 due to a multiple-photon absorbing phenomenon can be made to be efficiently incident to the spectroscope 16 by minimizing a loss along the optical path. Accordingly, a high signal-to-noise ratio spectroscopic detection can be realized.

Further, because a confocal pinhole is not used, the entire light from the specimen 5 which has been collected by the objective lens 3 can be led to the spectroscope 16. Accordingly, the present embodiment is particularly effective in detection of a feeble light, such as fluorescence, Raman scattering, or the like, which is emitted by a multiple-photon absorbing phenomenon.

Furthermore, the light from the specimen 5 is incident to the bundle fiber 14 in a state of being two-dimensionally deflected. However, the light from the specimen 5 is made to be a rectilinear radiation light along the slit 161 of the spectroscope 16 at the exit end 14b by being transmitted through the bundle fiber 14, and the rectilinear radiation light is made to be incident to the spectroscope 16 from the exit end 14b. Namely, the shape of the light from the specimen 5 can be fitted to the shape of the slit 161 of the spectroscope 16. Accordingly, the light collected by the objective lens 3 can be led to the spectroscope efficiently, and bright (high signal-to-noise ratio) and highly accurate spectroscopic detection can be carried out.

Moreover, the incident end plane 14a of the bundle fiber 14 is always at the conjugate position with the pupil 3a of the objective lens 3. Therefore, even light which has not been descanned can be thoroughly taken into the bundle fiber 14.

### Second Embodiment

A second embodiment of the present invention will be described.

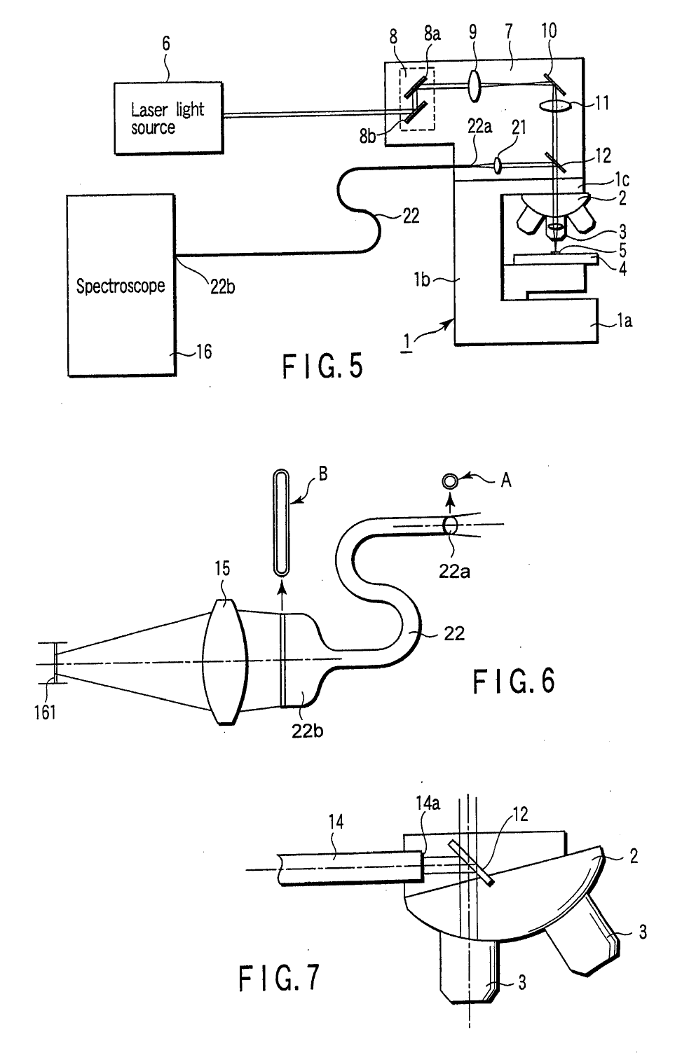

FIG. 5 is a diagram illustrating a schematic configuration of the second embodiment, and portions which are the same as those of FIG. 1 are denoted by the same reference numerals.

A condensing lens 21 is disposed on the optical path separated by the dichroic mirror 12. Further, an incident end 22a of a multi-mode fiber 22 serving as an optical fiber is disposed at the condensed position of the condensing lens 21. In addition, the spectroscope 16 is disposed at an exit end 22b of the multi-mode fiber 22.

The multi-mode fiber 22 whose core diameter is about several μm through 1000 μm is used as the multi-mode fiber 22. Further, the condensing lens 21 sufficiently collects the light, two-dimensionally deflected from the specimen 5, is made to be incident thereto from the dichroic mirror 12, and can make the light be incident to the incident end 22a of the multi-mode fiber 22.

In this case as well, as shown in FIG. 6, when there is a rectilinear slit at the incident opening of the spectroscope 16, the exit end 22b of the multi-mode fiber 22 is rectilinearly formed. It goes without saying that a condensing lens for condensing the emitted light onto the incident opening of the spectroscope 16 is provided at the exit end 22b of the multi-mode fiber 22.

The other portions are the same as those of FIG. 1.

In this way, because the incident end 22a of the multi-mode fiber 22 is disposed at the condensed position of the condensing lens 21 on the optical path separated by the dichroic mirror 12, the multi-mode fiber 22 having a core diameter which is about several μm through 1000 μm can be used as the multi-mode fiber 22.

In addition, the emitted light from the specimen 5 can be separated to the spectroscope 16 side by the dichroic mirror 12 without being returned to the scanner 8. Moreover, the light can be made to be a rectilinear radiation light along the slit 161 of the spectroscope 16 at the exit end side rectilinearly formed, by being transmitted through the multi-mode fiber 22. Accordingly, the same effects as those described in the first embodiment can be expected.

### Third Embodiment

A third embodiment of the present invention will be described.

FIG. 7 is a diagram illustrating a schematic configuration of a main portion of the third embodiment, and portions which are the same as those of FIG. 1 are denoted by the same reference numerals.

In the third embodiment, with respect to the revolver 2 holding the objective lens 3, the dichroic mirror 12 and the incident end plane 14a of the bundle fiber 14 are disposed so as to be close to the position of the pupil of the objective lens 3.

In this way, because the incident end plane 14a of the bundle fiber 14 is close to the position of the pupil of the objective lens 3, an amount of two-dimensional movement of the emitted light from the specimen 5 which is made to be incident onto the incident end plane 14a via the dichroic mirror 12 can be made small. Accordingly, by making the diameter of the bundle fiber 14 have an extra space, the light can be made to be directly incident to the incident end plane 14a without using a projection lens.

Due to the incident end plane 14a of the bundle fiber 14 being positioned at the directly rear of the objective lens 3, the light out of the optical axis of the objective lens 3 can be made to be even more incident thereto. Accordingly, because the light emitted from the specimen 5 can be made to be more efficiently incident to the spectroscope, a spectroscopic detection can be carried out at a high signal-to-noise ratio.

The present invention is not limited to the above-described embodiments, and at the stage of implementing the invention, various modifications are possible within the scope of the present invention. For example, in the embodiments described above, there has been described a multiple-photon laser microscope using an IR ultrashort pulsed laser as a laser light source. However, the present invention can be applied to a microscope which is a microscope which does not use a confocal effect and which is other than a multiple-photon laser microscope, and which carries out spectroscopic detection of fluorescence emitted from a specimen.

Moreover, inventions at various phases are included in the above-described embodiments, and various inventions can be considered due to a plurality of constitutional requirements which have been disclosed being appropriately combined. For example, even if some of the constitutional requirements are omitted from all of the constitutional requirements shown in the embodiment, provided that the problems discussed in the “Problems to be Solved by the Invention” section of the application can be solved, and the effects described in the “Effect of the Invention” section of the application can be achieved, the configuration from which the constitutional requirements are have been omitted can be considered to be the present invention.

Note that the following inventions are included in the above-described embodiments.

In accordance with the embodiments of the present invention, because the laser microscope is configured such that the light from the specimen is separated to the spectroscope side without being returned to optical scanning means, a loss of the light on half the optical path up to the spectroscope can be made to be a minimum. Accordingly, even a extremely feeble light, which has been emitted from the specimen, of a nonlinear phenomenon due to a multiple-photon absorbing phenomenon can be made to be efficiently incident to the spectroscope with a loss on the optical path being made to be a minimum. Further, because there is no pinhole on the optical path, the feeble light collected by the objective lens can be made to be efficiently incident to the spectroscope efficiently.

Further, according to the embodiment of the present invention, the light from the specimen is transmitted through the optical fiber. However, because the exit end of the optical fiber is rectilinearly formed, the shape of the light from the specimen can be fitted to the shape of the incident slit of the spectroscope, and the light collected by the objective lens can be led to the spectroscope efficiently.

Moreover, according to the present invention, because the incident end of the optical fiber is at the conjugate position with the pupil of the objective lens, even the light which has not been descanned can be thoroughly taken into the optical fiber.

As described above, according to the embodiments of the present invention, a laser microscope can be provided by which a high signal-to-noise ratio can be obtained, and in which a highly accurate spectroscopic detection can be carried out.

Additional advantages and modifications will readily occur to those skilled in the art. Therefore, the invention in its broader aspects is not limited to the specific details and representative devices, and illustrated examples shown and described herein. Accordingly, various modifications may be made without departing from the spirit or scope of the general inventive concept as defined by the appended claims and their equivalents.

What is claimed is:

1. A laser microscope comprising:
a laser light source which emits a laser light;
an objective lens which condenses the laser light from the laser light source onto a specimen;
an optical scanning unit which two-dimensionally scans the laser light on the specimen;
a dichroic beamsplitter which is positioned between the objective lens and the optical scanning unit, and which separates light emitted from a position on the specimen at which the laser light from the laser light source is condensed when the light from the laser light source is scanned on the specimen;
an optical fiber that includes an incident end that is disposed at an optical path separated by the beamsplitter, and to which the light from the specimen is made to be incident without being descanned;
a projection lens which is disposed at the optical path separated by the beamsplitter, and which projects a pupil of the objective lens onto an incident end plane of the optical fiber, said incident end plane of the optical fiber being positioned at a conjugate position with respect to the pupil of the objective lens; and
a spectroscope which is disposed at an exit end of the optical fiber, and to which light from the specimen which is emitted from the exit end is made to be incident, said spectroscope comprising a dispersive device which generates a spectrum,
wherein the laser light source emits an IR ultrashort pulsed laser light so as to generate a nonlinear phenomenon due to multiple-photon absorption at the specimen; and
wherein the exit end of the optical fiber is rectilinearly formed.
